(19) United States
(12) Patent Application Publication
(10) Pub. No.: US 2009/0120592 A1
(43) Pub. Date: May 14, 2009

(54) CONTROL UNIT FOR LIFT SYSTEM FOR COVERINGS FOR ARCHITECTURAL OPENINGS

(75) Inventor: Leo J. Lesperance, Boulder, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Hunter Douglas Inc., Upper Saddle River, NJ (US)

(21) Appl. No.: 12/263,580

(22) Filed: Nov. 3, 2008

Related U.S. Application Data
(60) Provisional application No. 60/987,861, filed on Nov. 14, 2007.

(51) Int. Cl. E06B 9/24

(52) U.S. Cl. 160/84.02

(57) ABSTRACT

A control unit for controlling a lift system in a covering for an architectural opening includes a drive assembly and a brake assembly. The drive assembly includes a spool about which a pull cord can be wrapped or unwrapped and a spring for biasing the spool in a direction to wrap the pull cord thereabout. A drive gear is operatively associated with the spool so that upon a pulling of the pull cord and unwrapping of the cord from the spool, the drive gear is shifted axially into engagement with a driven gear in the brake assembly. The driven gear under such circumstances rotates a driven shaft, which in turn rotates a lift shaft in the covering to raise the covering from an extended position to a retracted position.

### CROSS-REFERENCE TO RELATED APPLICATION

The present application claims benefit under 35 U.S.C. §119(e) to U.S. Provisional Patent Application No. 60/987,861, which was filed on Nov. 14, 2007 and entitled “Control Unit For Lift System For Coverings For Architectural Openings”, which is incorporated by reference into the present application in its entirety.

### BACKGROUND OF THE INVENTION

1. Field of the Invention

The present invention relates generally to control systems for operating retractable coverings for architectural openings and more particularly to a unit having a uni-directional drive assembly wherein the covering can be incrementally raised upon repeated reciprocating pull motions on a pull cord and a brake assembly operatively associated with the drive assembly wherein the brake assembly selectively prevents the shade from dropping by gravity.

2. Description of the Relevant Art

Coverings for architectural openings such as windows, doors, archways and the like take numerous forms such as conventional draperies, horizontal Venetian blinds, vertical blinds, roll-up shades and other coverings that resemble or define modifications of the aforenoted standard coverings. The control systems utilized to operate such coverings will vary depending upon the type of covering so that the roll-up shade, for example, would normally have a different control system than a vertical blind or a horizontal Venetian blind. Most control systems are operated with pull cords, pull tapes or tilt wands which depend from an end of a head rail and are manipulated by an operator to move the covering between extended and retracted positions in the architectural opening in which it is mounted. The suspended cords, tapes or wands may also tilt slats or vanes in the covering while the covering is extended across the architectural opening to selectively permit or prevent the passage of vision and light through the covering.

When pull cords or pull tapes are utilized, they are frequently endless thereby defining a depending loop at one end of the head rail. Loops of this type have presented problems in inadvertently causing physical harm to infants and young children who may catch a body part within the loop.

There has been a considerable amount of activity in recent years designed to remove the inherent danger in endless pull cords to young children and by way of example, the endless cords may be divided into two distinct cords so that no loop is present. The ends of such a divided cord may also be releasably connected so that under predetermined conditions or pressures, the ends of the cord will become separated to avoid harm to an infant. More recently, and as disclosed, for example, in U.S. Pat. No. 6,223,802 which is of common ownership with the present application, a single pull cord or tape is utilized to drive the system which is inherently safer than looped cords or tapes. A single pull cord or tape utilizes a uni-directional drive system that intermittently rotates a drive shaft in one direction. The drive shaft can be used in connection with various types of architectural coverings. With a unidirectional drive system, a pull cord or tape intermittently raises the covering while the covering is allowed to be extended by gravity upon the release of a brake which, when engaged, retains the covering in any degree of retraction.

It is to provide alternatives to the latter type of system that the present invention has been developed.

### SUMMARY OF THE INVENTION

The control unit of the present invention is provided in a single module and has an operatively interconnected drive assembly and brake assembly.

In one embodiment, the drive assembly includes a spool about which a pull cord can be wrapped or unwrapped and a spring biasing the spool in a wrapping direction. When the pull cord is pulled, it is unwrapped from the spool against the bias of the spring causing a spool shaft to rotate in one direction. Rotation of the spool shaft in the one direction causes a drive gear to advance axially along the spool shaft away from the spool and into operative engagement with a driven gear in the brake assembly. A resilient member is provided for biasing the drive gear away from the driven gear so that they are only engaged upon rotation of the spool shaft in the one direction. In other words, when the pull cord is being unwrapped from the spool by manually pulling on the cord, the spool shaft is rotated in a direction that causes the drive gear to move axially into engagement with the driven gear, but when the pull cord is no longer being pulled and allowed to rewrap around the cord spool under the bias of the springs, the drive and driven gears are disengaged. Accordingly, the drive assembly is only operative in rotating or driving the driven gear in one direction and then only selectively when the pull cord is being pulled or unwrapped from its spool.

The brake assembly in the aforenoted embodiment includes the driven gear and a driven shaft on which it is mounted for unitary rotation. The driven shaft is, in turn, operatively connected to a lift shaft for the covering, which includes lift cords for raising or lowering the covering in a conventional manner. Accordingly, when the driven shaft is rotated, so are the lift shaft and a lift system within a head rail of the covering. A one-way brake in the brake assembly selectively prevents the drive shaft from rotating when it is not being driven by the drive assembly and therefore retains the covering at any selected degree of retraction within the architectural opening. A release system, however, is operatively associated with the driven shaft and allows the driven shaft to rotate in an opposite direction when the one-way brake is released. The release system includes a governor and a gear train operatively connected to the driven shaft so that if the governor is prevented from rotating the driven shaft is also prevented from rotating in the afore noted opposite direction. The release system, however, is operative to selectively permit rotation of the governor, which in turn permits rotation of the driven shaft in the aforenoted opposite direction, which thereby allows the covering to drop by gravity from any degree of retraction.

The release system includes a dog engageable with a gear on the governor and the dog is moved between engaging and nonengaging relationships with the governor gear through manipulation of the pull cord. The pull cord has an operative relationship with a lock lever for moving the dog between the engaging and nonengaging positions.

Pursuant to the above, the control unit has a pull cord operated drive assembly for rotating a driven shaft in a single direction with the pull cord also being operative on a one-way brake for selectively preventing rotation of the driven shaft in an opposite direction. In this manner the covering can be raised or lowered to any desired degree.

In a second embodiment of the invention, the drive assembly is different from that of the first-described embodiment in that a spring clutch is utilized to unidirectionally drive the driven shaft with the driven shaft being again mounted for unitary rotation with the lift shaft for the covering, which includes lift cords for raising or lowering the covering, as described with the first embodiment. The driven shaft is also operatively connected to a one-way brake in a brake assembly similar to that previously summarized, which prevents the driven shaft from rotating when it is not being unidirectionally driven by the drive assembly and therefore retains the covering at any selected degree of extension or retraction within the architectural opening. Again, a release system is operatively associated with the driven shaft and allows the driven shaft to rotate in an opposite direction when the one-way brake is released. The release system is identical to that of the first embodiment.

The drive assembly in the second embodiment includes a cord spool about which a pull cord can be wrapped or unwrapped and a spring-biasing system for biasing the spool in a wrapping direction. When the pull cord is pulled, it is unwrapped from the spool against the bias of the spring causing a spool shaft to rotate in one direction. The biasing spring is mounted in a housing adjacent to the spool shaft and has a drive gear operatively engaged with a gear on the cord spool with the drive gear coiling the biasing spring when the spool shaft is rotated in an unwrapping direction. Under predetermined conditions, the coil spring rotates the cord spool in an opposite direction to wrap the pull cord therearound. When the spool shaft is rotating in an unwrapping direction, it causes a spring clutch operatively associated therewith to grip the spool shaft as well as the driven shaft so that rotation of the spool shaft in an unwrapping direction causes the driven shaft to also rotate in unwrapping direction. However, when the cord spool is rotated in the opposite wrapping direction by the biasing spring causing the pull cord to wrap around the cord spool, the spring clutch permits the spool shaft to rotate relative to the driven shaft so the driven shaft remains in a fixed position as the cord spool is being rewound.

Other aspects, features and details of the present invention can be more completely understood by reference to the following detail description of a preferred embodiment, taken in conjunction with the drawings and from the appended claims.

### BRIEF DESCRIPTION OF THE DRAWINGS

FIG. 1 is an isometric of a covering incorporating the control unit of the present invention shown in a fully retracted condition.

FIG. 2 is an isometric similar to FIG. 1 with the covering shown in a fully extended condition.

FIG. 3 is a front elevation showing the covering of FIG. 1 moving from a retracted to an extended position and with the pull cord in a position to release the covering to permit extension.

FIG. 4 is a front elevation of the covering of FIG. 1 showing the covering being retracted from an extended position and with a pull cord being reciprocated to incrementally retract the covering.

FIG. 5 is an exploded isometric of the covering of the present invention showing the control unit of the present invention and other components of the covering of FIG. 1.

FIG. 6 is an isometric looking downwardly on the control unit of the present invention shown in a two-part housing having top and bottom components.

FIG. 7 is an isometric similar to FIG. 6 shown from a different angle with the top component of the housing removed.

FIG. 8 is an exploded isometric of the control unit of the present invention seen from a first angle looking downwardly on the control unit.

FIG. 9 is an isometric similar to FIG. 8 with the housing having been removed and looking downwardly on the components from a different angular direction.

FIG. 10A is an enlarged section taken along line 10A-10A of FIG. 7.

FIG. 10B is a section similar to FIG. 10A showing the drive and driven gears and their related components in driving relationship as opposed to the non-driving relationship of FIG. 10A.

FIG. 11A is an enlarged fragmentary section taken along line 11A-11A of FIG. 10A.

FIG. 11B is an enlarged fragmentary section taken along line 11B-11B of FIG. 10B.

FIG. 12 is an enlarged section taken along line 12-12 of FIG. 7.

FIG. 13 is an enlarged section taken along line 13-13 of FIG. 7.

FIG. 14 is an enlarged section taken along line 14-14 of FIG. 7.

FIG. 15 is an enlarged section taken along line 15-15 of FIG. 7.

FIG. 16A is a section taken along line 16A-16A of FIG. 12 showing the dog in an engaged relationship with the governor gear.

FIG. 16B is an isometric showing the dog, the governor, the lock lever for moving the dog and the control cord, with the dog in an engaged relationship with the governor gear.

FIG. 16C is an enlarged fragmentary section taken along line 16C-16C of FIG. 16B.

FIG. 16D is a section taken along line 16D-16D of FIG. 16C.

FIG. 17A is a section similar to FIG. 16A showing the dog in a nonengaged relationship with the governor gear.

FIG. 17B is an isometric similar to FIG. 16B showing the dog in a nonengaging relationship with the governor gear.

FIG. 17C is an enlarged section taken along line 17C-17C of FIG. 17B.

FIG. 17D is a section taken along line 17D-17D of FIG. 17C.

FIG. 18 is an exploded isometric of the drive system and half of the housing for a second embodiment of the control unit of the present invention.

FIG. 19 is an exploded isometric of the opposite housing component from that shown in FIG. 18 and the recoil or biasing spring and its drive gear.

FIG. 20 is a vertical section through the second embodiment of the control unit of the invention illustrating the interconnection of the components of the drive assembly of the second embodiment incorporated into the housing for the control unit.

FIG. 21 is an isometric view showing the drive assembly and the brake assembly used in the control unit of the second embodiment with the components positioned within one half of the housing for the control unit.

FIG. 22 is an isometric looking from a different direction than that of FIG. 21.

FIG. 23 is a section taken along line 23-23 of FIG. 20.

FIG. 24 is a section taken along line 24-24 of FIG. 20.

FIG. 25 is a section taken along line 25-25 of FIG. 24.

FIG. 26 is a vertical section taken through the control unit of the second embodiment of the invention mounted in a headrail and illustrating the passage of the pull cord from the spool through the control unit and headrail.

FIG. 27 is a section similar to FIG. 26 showing the control unit in a slightly larger headrail.

FIG. 28 is a section similar to FIG. 27 with the control unit shown in an even larger headrail.

FIG. 29 is a section similar to FIG. 26 showing the pull cord disposed on the opposite side of the headrail.

FIG. 30 is a section similar to FIG. 27 with the pull cord disposed on the opposite side of a larger headrail.

FIG. 31 is a section similar to FIG. 28 with the pull cord disposed on the opposite side of an even larger headrail.

### DESCRIPTION OF THE PREFERRED EMBODIMENT

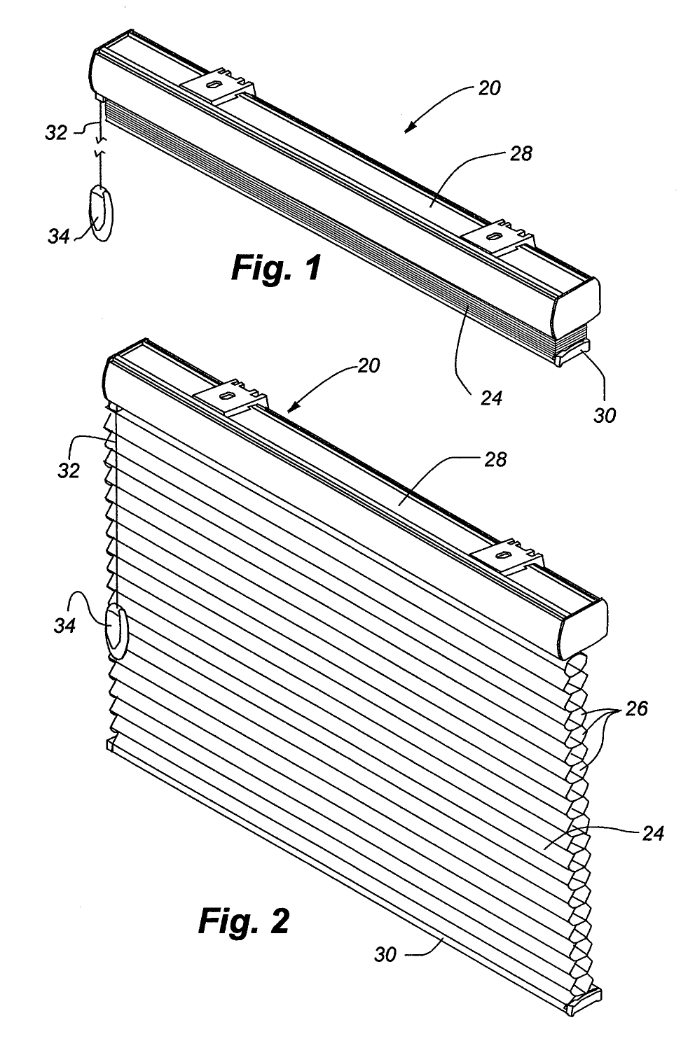

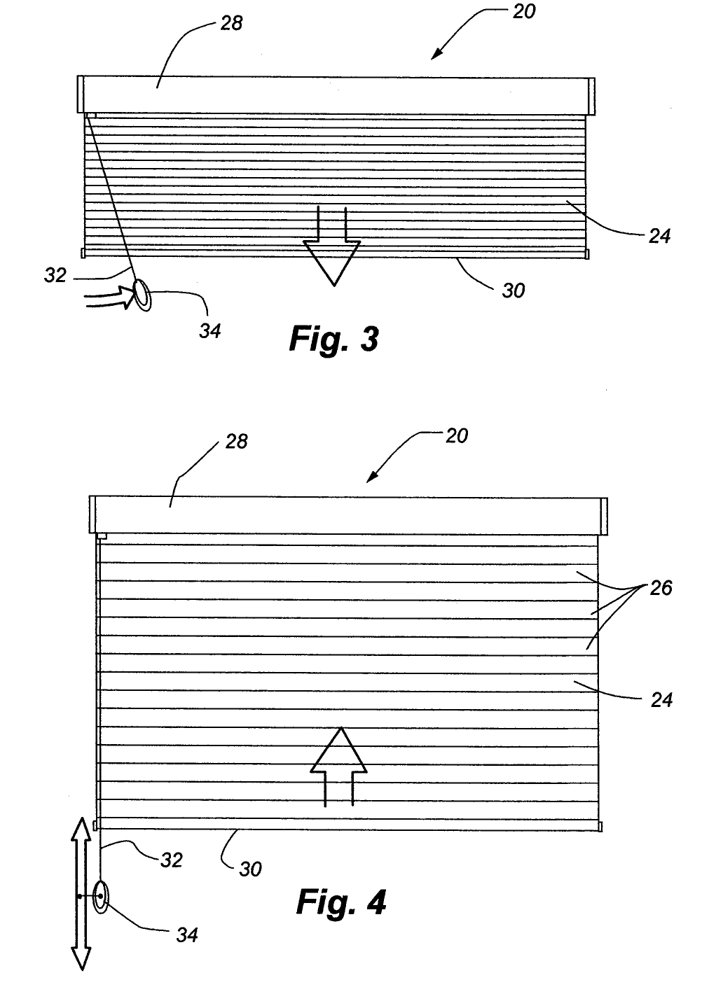

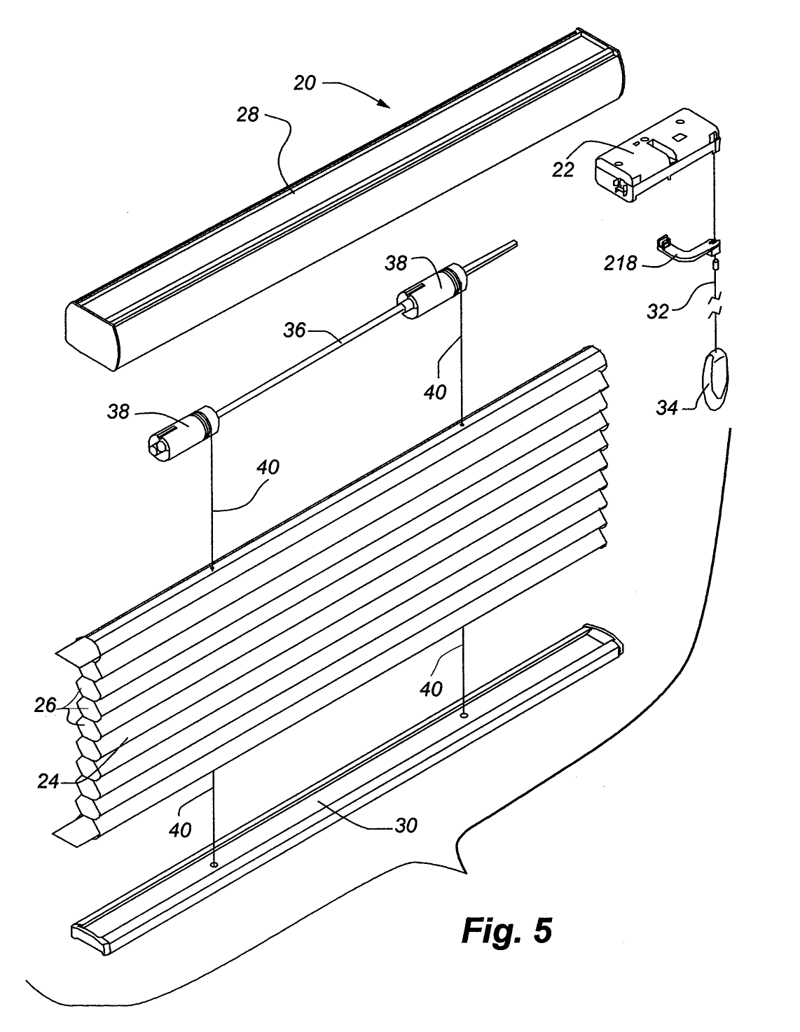

A covering 20 for an architectural opening (not shown) incorporating a first embodiment of a control unit 22 in accordance with the present invention is illustrated in FIGS. 1 through 4. It is to be appreciated the covering illustrated is for exemplary purposes only as the control unit would be useful with various types of retractable coverings found in architectural openings. In the covering illustrated, a cellular shade material 24 having horizontally disposed interconnected transversely collapsible cells 26 is suspended from a head rail 28 by a lift system with a weighted bottom rail 30 being secured along the lower edge of the shade material. The covering is of the retractable type so that it can be fully extended as shown in FIG. 2, fully retracted as shown in FIG. 1 or partially extended to any degree between the fully extended and retracted positions. As will be appreciated with the description of the control unit hereafter, it is operated with a single pull cord 32 having a tassel 34 on a lower end so the pull cord can be reciprocally moved vertically by pulling the cord downwardly and allowing it to automatically retract upwardly in a manner to be described hereafter. A downward pulling movement, when the control unit is in a raising mode or condition, will incrementally raise the bottom rail a predetermined amount with each pulling motion and while the pull cord is being automatically retracted, the bottom rail will remain in a fixed position until the pull cord is again pulled downwardly causing the bottom rail to raise another incremental amount. This process is repeated until the shade material is fully retracted as shown in FIG. 1. This movement is illustrated in FIG. 4 where it can be seen the pull cord is moved vertically up and down and with each downward stroke, the shade material is elevated a predetermined amount. Also as will be described in more detail hereafter, the pull cord can be shifted laterally to one side to switch the control unit from a raising mode or condition to a lowering mode or condition and this is illustrated in FIG. 3. In other words, by shifting the tassel to the right when the pull cord is mounted at the left edge of the covering, a brake is released to allow the shade to drop by gravity any desired amount.

The covering 20 illustrated in FIGS. 1 through 4 is shown in a diagrammatic exploded view in FIG. 5 where it will be appreciated the control unit 22 of the invention is positioned within the head rail 28 for the covering with the head rail also supporting a lift shaft 36 having a plurality of lift spools 38 around which lift cords 40 having their lower ends anchored to the bottom rail 30 of the covering can be wrapped. The lift spools rotate with the lift shaft so that in order to retract the covering from the extended position of FIG. 2 to the retracted position of FIG. 1, the lift shaft is rotated in one direction causing the lift cords to wrap around their associated spools and to extend the covering from the retracted position, the lift shaft is rotated in an opposite direction to allow the lift cords to unwrap from their associated spools thereby allowing the bottom rail to drop and extending the shade material between the head rail and the bottom rail.

Rotation of the lift shaft 36 is effected with the control unit 22 of the present invention, which is designed to drive rotational movement of the lift shaft in one direction by reciprocally pulling the pull cord 32 downwardly and then allowing it to retract automatically. Therefore, with each pulling motion of the pull cord, the lift shaft is rotated a predetermined number of rotations causing the bottom rail 30 to elevate a predetermined distance. Continuing to pull the pull cord downwardly and allowing it to retract upwardly can incrementally retract the shade any desired amount. A brake assembly 42 (to be described hereafter) within the control unit will normally retain the bottom rail in a fixed position unless the pull cord is being pulled downwardly, but the brake assembly can be released to allow the bottom rail to drop by gravity. In such instance, the lift shaft rotates in an opposite direction, which is caused by the weight of the bottom rail being drawn down by gravity, thereby extending the shade material from the retracted position of FIG. 1 to the extended position of FIG. 2. A governor 44 within the control unit, which will be described in detail hereafter, controls the speed at which the bottom rail can drop by gravity, thereby controlling the speed of extension of the covering.

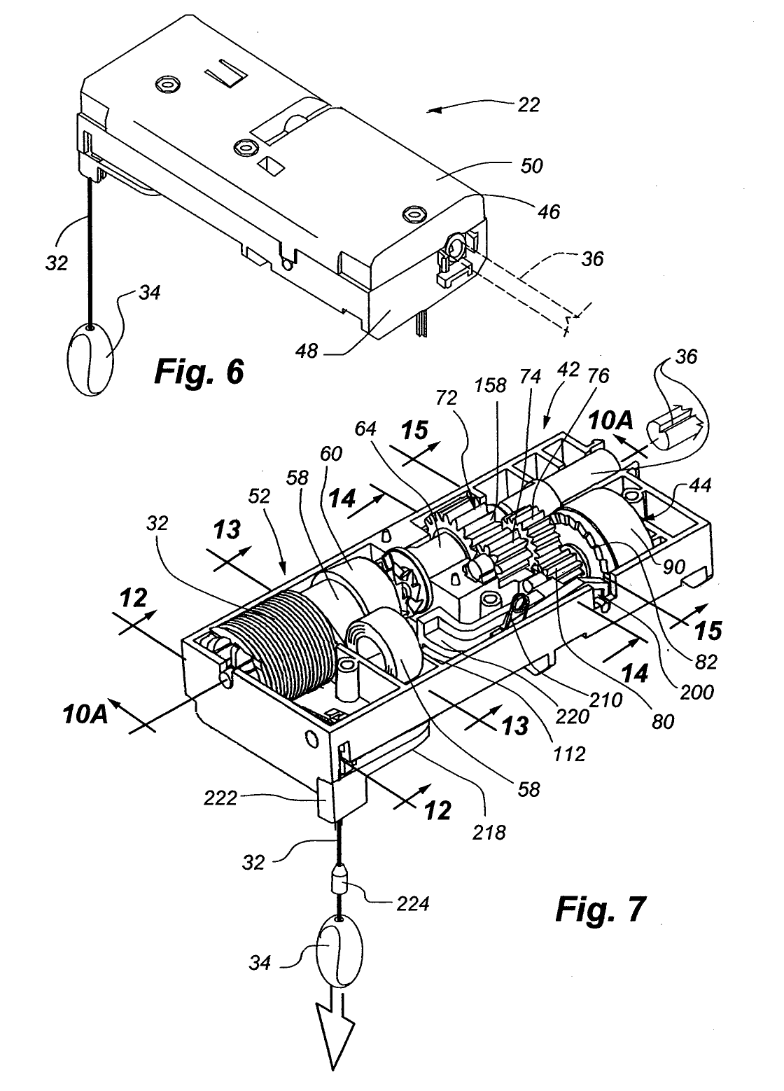

Referring to FIGS. 6 through 9, the control unit 22 of the present invention can be seen to include a two-part housing 46 having a bottom component 48 and a top component 50 wherein both the top and bottom components have complimentary ribbing formed therein for confining the various operative elements of the control unit between the top and bottom components. Of course, the top and bottom components can be interconnected in any suitable manner as shown in FIG. 6 so the operative components are properly confined and in one compact unit for mounting in any suitable manner within the head rail 28 of the covering.

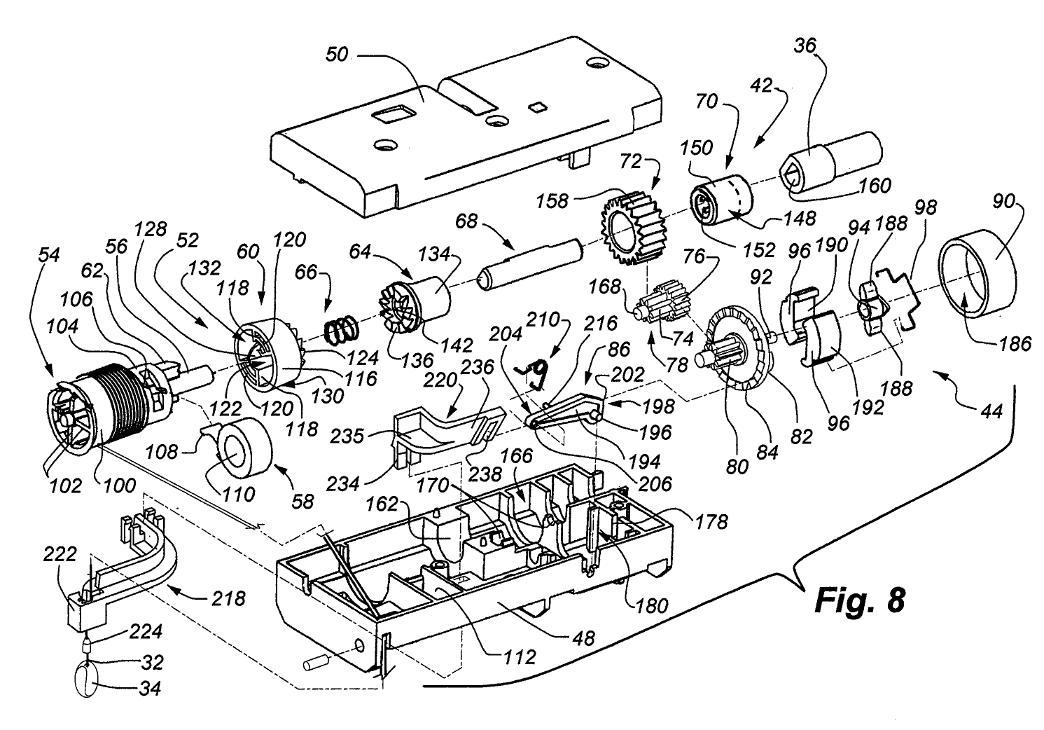

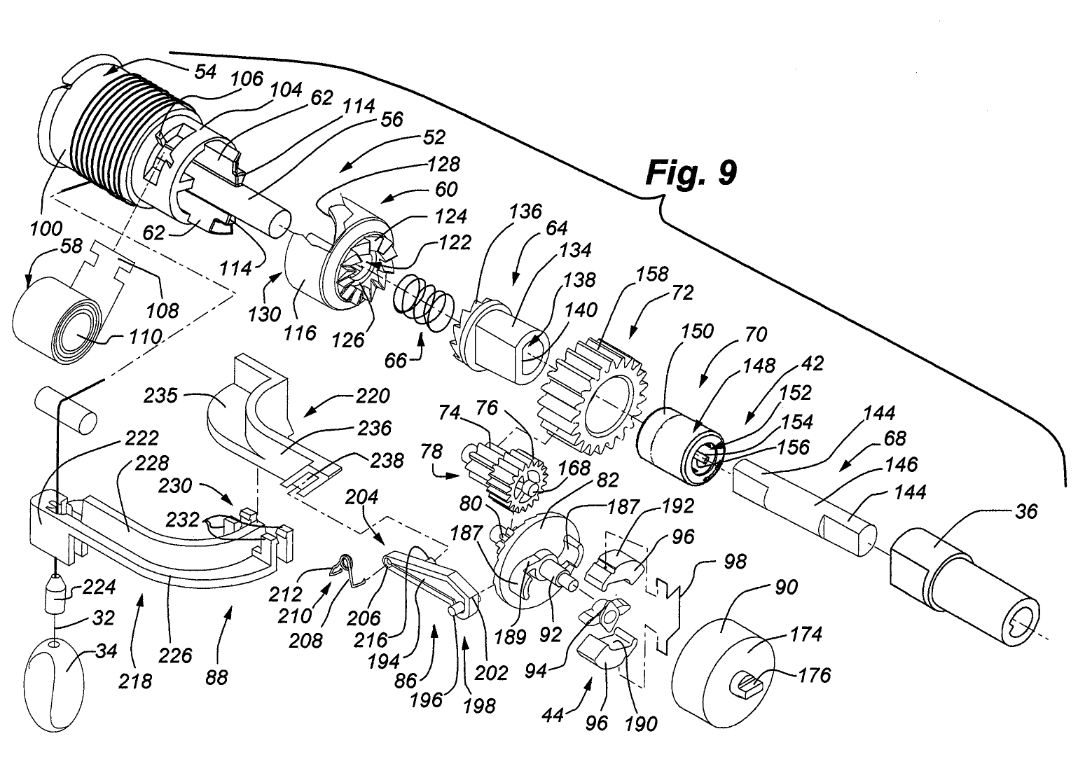

As probably best appreciated by reference to FIGS. 8 and 9, the control unit 22 has an operatively interconnected drive assembly 52 and the brake assembly 42. The drive assembly includes a spool 54 having a spool shaft 56 integral therewith with the spool anchoring an upper end of the pull cord 32 with the lower end of the pull cord having the tassel 34 secured thereto for manipulation of the pull cord by an operator. A recoil spring 58 in the drive assembly, which is dual wrapped during operation, is confined within the housing 46 and operably interconnected with the spool to bias the spool for rotation in a clockwise direction as viewed in FIG. 8 or counterclockwise direction as viewed in FIG. 9. A drive gear 60 also forming part of the drive assembly is mounted on the spool shaft for unitary rotation therewith and includes a portion of a cam system that cooperates with diametrically opposed legs 62 on the spool shaft for axially moving the drive gear away from the spool upon rotation of the spool in a raising direction as when the pull cord is being pulled downwardly. The drive gear is therefore slidably mounted on the spool shaft to accommodate the axial movement while being confined to the shaft for unitary rotation therewith.

The brake assembly 42, also probably best seen in FIGS. 8 and 9, includes a driven gear 64 in confronting relationship with the drive gear 60, and in a position to be engaged by the drive gear when the drive gear is cammed away from the spool 54. A coil spring 66 is seated in the confronting faces of the drive and driven gears to bias the drive and driven gears away from each other. Accordingly, when the drive gear is not being moved away from the spool by the cam system, the coil spring 66 forces the drive gear axially toward the spool and out of engagement with the driven gear. The driven gear is mounted on a driven shaft 68 for unitary rotation therewith. The driven shaft also supports a one-way bearing or brake 70 that carries a first pinion gear 72 fixed thereto for unitary rotation therewith. The driven shaft is further adapted for connection with the lift shaft 36 of the covering so that the lift shaft rotates in unison with the driven shaft in operation of the covering.

Second 74 and third 76 pinion gears are integrally connected in a single unit 78 with the second pinion gear being meshed with the first pinion gear 72 and the third pinion gear being meshed with a fourth pinion gear 80 carried by a rotatable face plate 82 of the governor 44. The faceplate also has ratchet teeth 84 around its periphery for selective engagement with a pivotal dog 86 movable between engaging and disengaging positions by a two-piece lock lever or trigger arm 88. The lock lever is manipulated by hand manipulation of the pull cord 32 as will be described later. The governor has a cylindrical base 90 with a circular open end for rotatable receipt of the rotatable faceplate 82. The face plate further includes an axial support shaft 92 that supports a governor drive element 94, a pair of floating friction bars 96 and a spring clip 98 for pivotally interconnecting the spring bars about the governor drive element. As will be appreciated with the more detailed description hereafter, the governor is adapted to control the rate of free rotation of the driven shaft 68 through the pinion gear train so that the shade moves from a retracted to an extended position at a controlled speed.

Looking more specifically at the components of the drive assembly 52 which include the spool 54, its integral spool shaft 56, the drive gear 60 and the recoil dual wrap spring 58, reference is made to FIGS. 7, 8 and 9. It will there be appreciated the spool has an enlarged cylindrical cord wrap surface 100 spaced concentrically from the spool shaft 56 by a plurality of radial ribs 102 and an adjacent, relatively small cylindrical spring wrap surface 104 for the recoil spring 58. A slot 106 is provided in the relatively small spring wrap surface of the spool for anchoring a tab 108 on the end of the recoil spring so that rotation of the spool in the counterclockwise direction as viewed in FIG. 8 by pulling the pull cord downwardly causes the dual wrap spring to unwind from its base coil 110 and wrap around the relatively small cylindrical spring wrap surface of the spool thereby biasing the spool in the opposite or clockwise rotating direction. The base coil of the dual wrap recoil spring itself is seated in a pocket 112 defined by ribbing in the top 50 and bottom 48 components of the housing 46 so that it can feed spring material to the spool as the spool is rotated and rewind the spring material into the pocket when the spool is being recoiled.

The spool shaft 56 is of a relatively small diameter supporting the cord wrap surface 100 at an end opposite the end, which receives the drive gear 60. The spool shaft also includes the pair of diametrically opposed legs 62 which extend axially in parallel adjacent relationship with the spool shaft. Each leg has a tapered or beveled end 114 forming a part of the previously mentioned cam system for axially moving the drive gear as will be explained hereafter.

The drive gear 60 has an outer cylindrical surface 116 and inwardly radiating ribs 118 interconnected by arcuate supports 120 so as to define a cylindrical passageway 122 through the drive gear. On the end of the drive gear furthest removed from the spool 54 are a plurality of ratchet teeth 124 circumferentially disposed about the passageway for engagement with the driven gear 64 as will be appreciated hereafter. Further, a recess or spring seat 126 is provided within the circular array of the ratchet teeth and around the passageway 122 for receipt of one end of the coil spring 66. Within the interior of the drive gear, and along a substantially circular arch formed therein, a pair of diametrically opposed arcuate cam ridges 128 are defined, as seen in FIGS. 8 and 9, that taper from a location near a rear face of the end of the gear having the ratchet teeth 124 to a location adjacent the open rear 130 of the drive gear. Each arched cam ridge 128 is aligned with the tapered end 114 of one of the legs 62 on the spool shaft 56 with the tapered ends acting as cam surfaces that cooperate with the arcuate cams within the drive gear. The arcuate cams within the drive gear are confined within pockets 132 defined in the drive gear adapted to receive the legs 62 with each pocket being between a pair of radiating ribs 118 so the legs are confined within a pocket with the tapered ends and the arcuate cam ridges in engagement with each other under the bias of the coil spring 66.

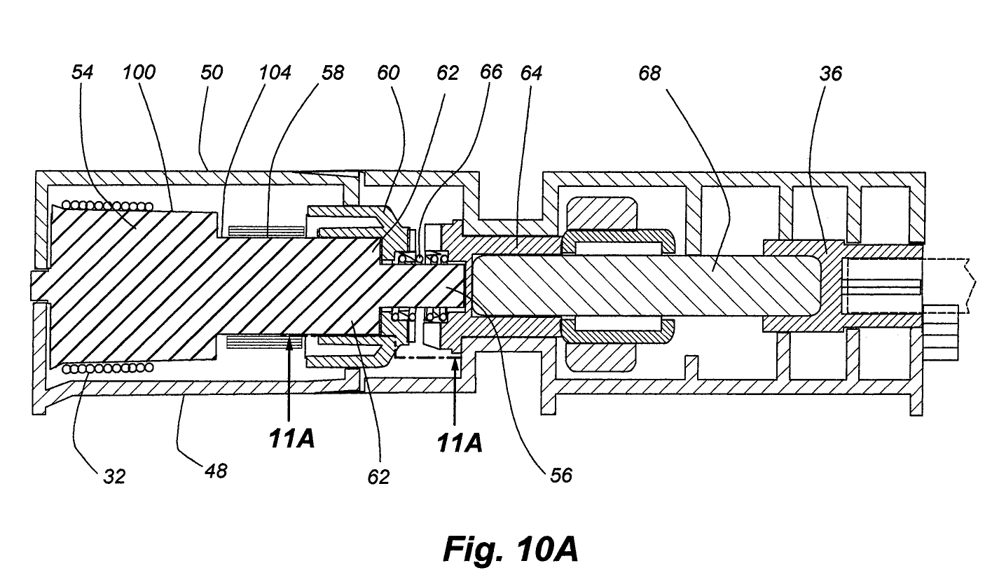

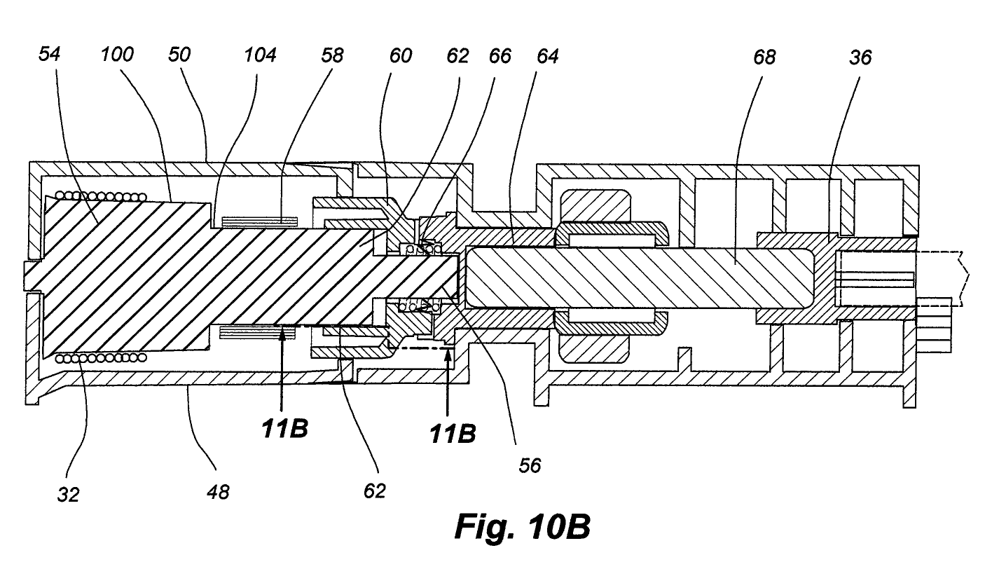

Rotating movement of the spool 54 in a counterclockwise direction as viewed in FIG. 8, or a clockwise direction as viewed in FIG. 9, as is caused when the pull cord 32 is pulled and being unwrapped from the spool causes the tapered cam ends 114 of the legs 62 to ride along the arcuate cam ridges 128 within the drive gear 60 thereby forcing the drive gear away from the spool and toward the driven gear 64 in the brake assembly 42. This axial movement of the drive gear caused by the cam system is against the bias of the coil spring 66 which is seated in the outer front face of the drive gear 60 so upon an opposite direction of rotation of the spool, as when the pull cord is being wrapped on the spool, the coil spring forces the drive gear axially toward the spool into a retracted position of the drive gear (FIG. 10A). In the retracted position of the drive gear, it is disengaged from the driven gear 64 of the brake assembly. In the extended position of the drive gear (FIG. 10B), caused by the cam system upon counterclockwise rotation of the spool as viewed in FIG. 8, the drive gear is cammed to engage the driven gear as will be described in more detail hereafter.

The driven gear 64 which forms part of the brake assembly 42 and as probably best seen in FIGS. 8 and 9, includes a generally cylindrical body 134 having an enlarged disc like end with peripheral ratchet teeth 136 formed thereon that confront the ratchet teeth 124 of the drive gear 60 of the drive assembly 52. The driven gear has a non-cylindrical axial passage 138 therethrough, in the disclosed embodiment in the form of a partial cylinder having a flat side 140. A circular seat or recess 142 is formed in the disc-like end of the driven gear within the ratchet teeth and around the passage 138 with the seat being adapted to support the opposite end of the coil spring 66 from the end seated in the drive gear. The coil spring 66 thereby biases the driven gear away from the drive gear.

The driven shaft 68 has three integral component parts with opposite end components 144 being of a configuration complimentary to the non-cylindrical passage 138 through the driven gear 64 and a center or central component 146 of cylindrical configuration.

The one-way bearing or brake 70 is adapted to sit on the center cylindrical portion 146 of the driven shaft 68 and is a conventional one-way bearing having a cylindrical body 148 with an outer cylindrical surface 150 and a cylindrical passage 152 therethrough. Between the outer surface and the passage a plurality of longitudinally extending roller bearings 154 are seated in cavities so as to protrude through slots 156 into the passage 152 where they engage the center component 146 of the driven shaft. The roller bearings are designed so that they will rotate about their own longitudinal axes in one direction but cannot rotate in an opposite direction. In this manner, they permit the one-way bearing 70 to rotate about the center component 146 of the driven shaft in one direction but prevent rotation of the one-way bearing about the drive shaft in the opposite direction.

The first pinion gear 72 is press fit or otherwise secured around the outer surface 150 of the one-way bearing 70 and includes a plurality of circumferential radially directed teeth 158. The first pinion gear therefore rotates in unison with the one-way bearing.

The end components 144 of the driven shaft 68 protrude out opposite ends of the one-way bearing 70 so that one end component is received in the complimentary passageway of the driven gear 64 and the other end component is received in a complimentary axial recess 160 in the end of the lift shaft 36 for the covering 20. The non-cylindrical configuration of the end components 144 and the recesses or passageways in which they are received cause the driven shaft, driven gear and lift shaft to rotate in unison. As mentioned, the one-way bearing will rotate in unison with the driven shaft in one direction but will rotate relative to the driven shaft in the opposite direction.

As probably best appreciated by reference to FIGS. 7 and 8, the bottom-housing component 48 includes a relatively large rib 162 defining a substantially semi-cylindrical cradle in which the cylindrical body 134 of the driven gear 64 is rotatably positioned. A pocket 166 is defined in the bottom-housing component for rotatable receipt of the first pinion gear 72 so that the pinion gear 72, the driven shaft and the lift shaft are free to rotate within and relative to the lower housing component. The upper housing component 50 has complimentary ribbing so as to enclose the pockets in which the various operative elements of the control unit are permitted to rotate.

The second 74 and third 76 pinion gears form the single unit 78 and are therefore integrally connected. The unit has an axial support shaft 168 that protrudes from opposite ends. Cradle-like supports 170 are provided in the housing components for rotatably supporting the second and third pinion gear unit so that the second pinion gear is meshed with the first pinion gear 72.

The governor 44, as probably best appreciated by reference to FIGS. 8 and 9, includes the cylindrical base 90 having a closed end wall 174 with a flat finger 176 protruding outwardly and axially from the closed end wall. The flat finger is adapted to be received in a vertical slot 178 (FIG. 8)in the bottom housing component 48 so that the cylindrical base for the governor is positioned within a cavity 180 defined in the housing and will not rotate relative to the housing. The opposite end of the cylindrical base is open and has the rotatable circular plate 82 positioned therein enclosing the open end of the base. The end plate has a peripheral array of ratchet teeth 182 and the fourth pinion gear 80 projecting outwardly therefrom and also includes the support shaft 92 that protrudes in opposite directions from the rotatable plate. One end of the support shaft is adapted to be seated in a recess (not seen) provided in the closed end wall of the base for the governor while the other end of the shaft is supported in cradles 184 defined in the housing components. When the base for the governor and the rotatable end plate are properly positioned within the housing, the fourth pinion gear on the rotatable plate meshes with the third pinion gear 76 of the unit 78 previously described.

As seen best in FIGS. 8 and 9, the governor base 90 and the rotatable end plate 82 define a cavity 186 within the base that receives the governor drive element 94 and the pair of floating friction bars 96 which are pivotally interconnected by the spring clip 98. The governor drive element is rotatable relative to the support shaft 92 but is sized to engage arcuate legs 187 on a spider 189 that is integral with the rotating plate 82. Accordingly, the legs 187 engage diametrically opposed fingers 188 on the drive element upon rotation of the plate 82 to carry the drive element with the rotation of the plate 82. The legs 187 also form pockets for receiving an end of a friction bar about which the friction bars pivot against the bias of the spring clip 98. The floating friction bars are somewhat arcuate in configuration defining pockets 190 on an interior face thereof and an arcuate outer face 192 having a radius equivalent to the inner radius of the cylindrical base 90 of the governor so that the arcuate surfaces of the floating friction bars can selectively engage the inner surface of the cylindrical base. The fingers 188 on the governor drive element are adapted to be seated in the pockets 190 defined on the floating disc bars so that upon rotation of the governor drive element, the fingers will force the floating friction bars to rotate therewith and the spring clip will allow the floating friction bars to pivot outwardly against the bias of the spring clip upon a pre-determined centrifugal force or speed of rotation of the end plate thereby throwing the floating friction bars into frictional engagement with the inner surface of the governor base. In this manner, the faster the end plate rotates the more friction generated between the friction bars and the base for the governor thereby inhibiting the speed of rotation.

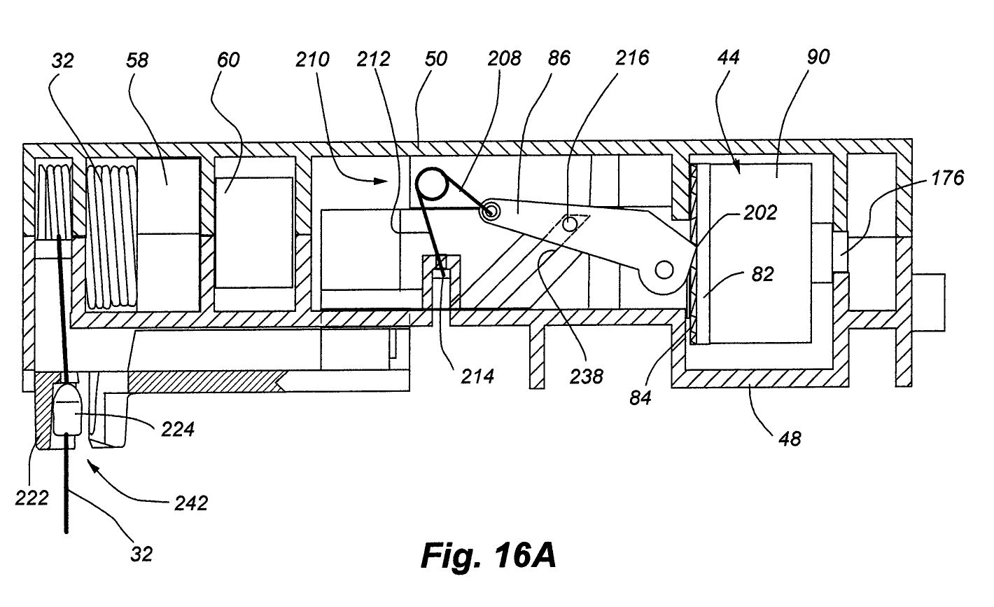

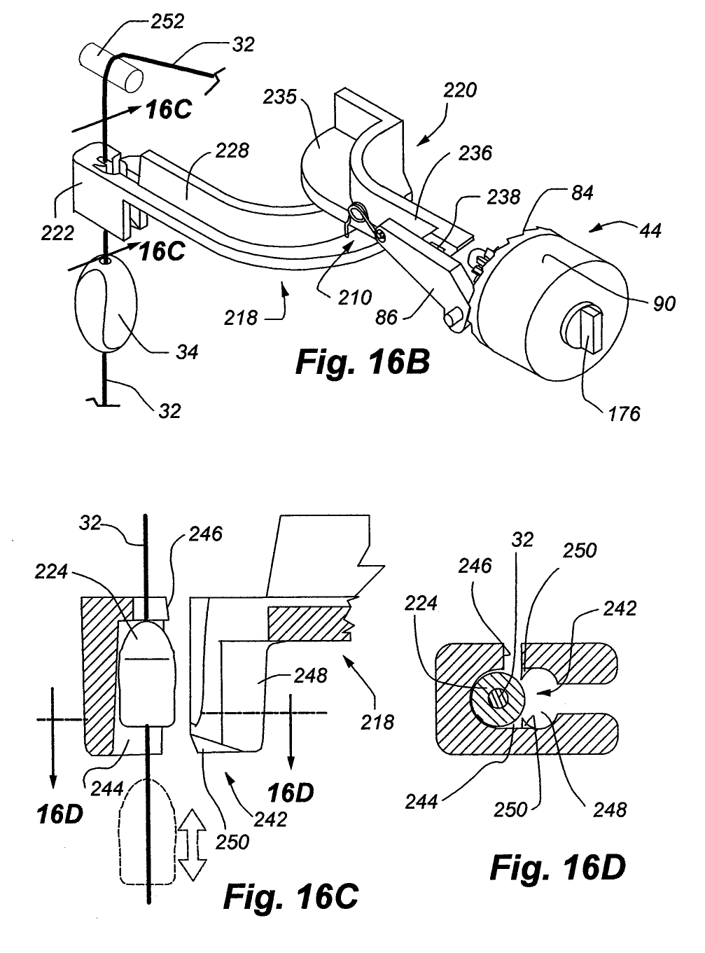

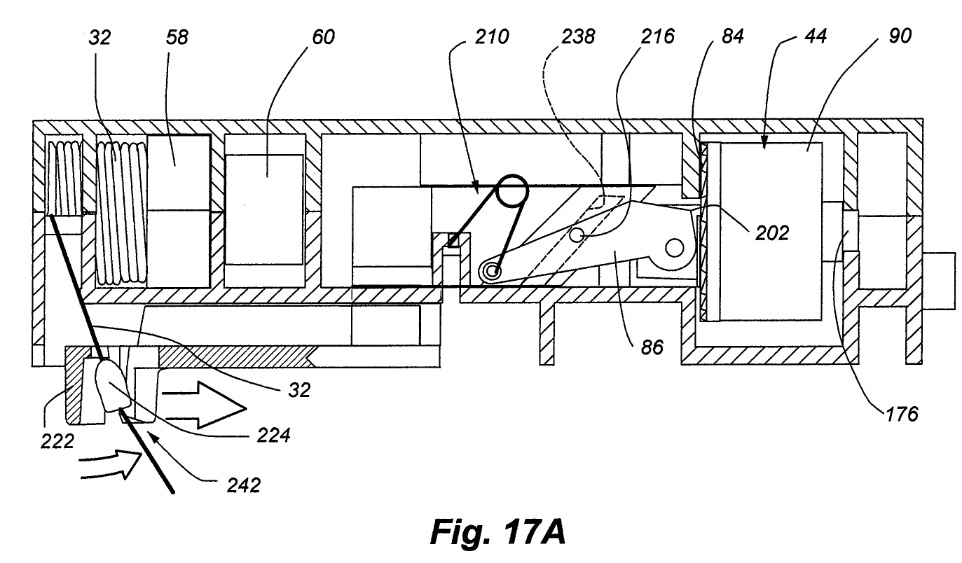

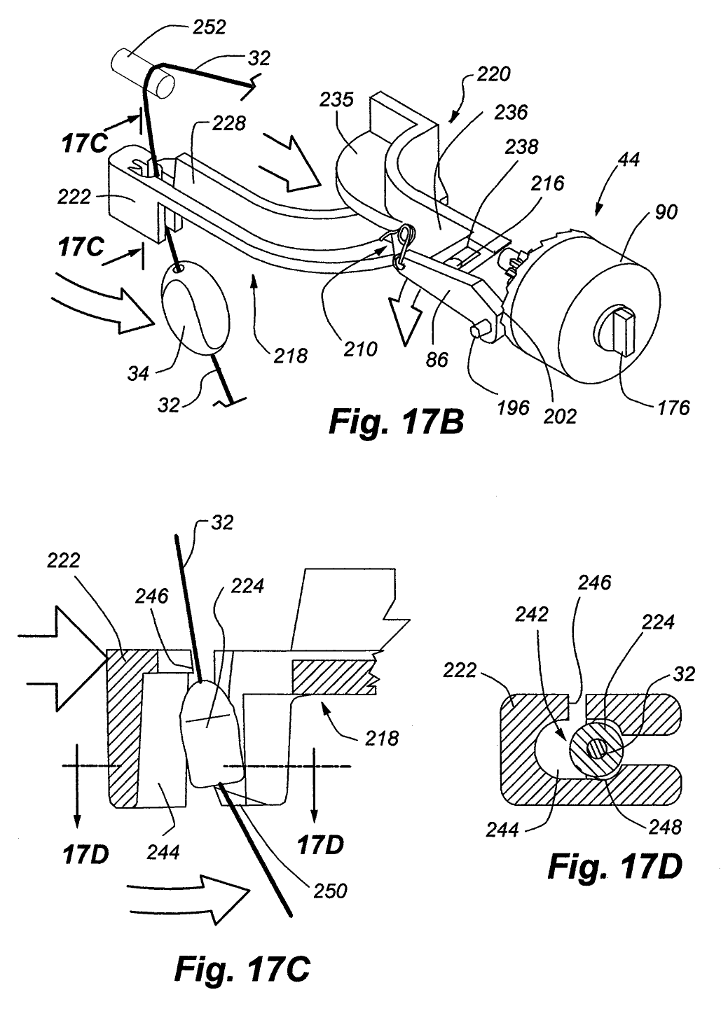

The dog 86 (FIGS. 8, 9, 16A, 16B, 17A, and 17B) has an elongated generally triangularly shaped bar 194 with a transverse pivot pin 196 at a large end 198 thereof that is rotatably seated on cradles 200 (FIG. 7) within the lower housing component 48 and confined therein by the complimentary relationship of the upper housing component 50 with the bottom housing component. The large end of the dog immediately above the pivot pin has an outer edge that defines an obtuse angle forming a catch 202 on the dog adapted to selectively engage the peripheral teeth 182 in the face of the rotatable plate 82 of the governor 44. The opposite end 204 of the dog or its narrow end has a transverse passage 206 that anchors one arm 208 of a coil spring 210, the other arm 212 of which is anchored in a slot 214 provided in the bottom housing component (FIG. 16A). As will be appreciated with the description hereafter, the coil spring 210 is adapted to releasably retain the dog in an engaging or non-engaging position with the engaging position (FIG. 16A) having the catch 202 in engagement with the ratchet teeth on the rotatable plate of the governor and the non-engaging position (FIG. 17A) having the catch out of engagement with the ratchet teeth. In other words, the dog is provided to permit or prevent rotation of the governor end plate and therefore the components within the governor and the gear train leading from the rotatable plate to the one-way bearing 70 and the driven shaft 68.

An inwardly directed transverse guide pin 216 is also provided on the dog 86 near its center with this guide pin adapted to cooperate with the lock lever or trigger arm 88 in a manner to be described hereafter so that movement of the lock lever shifts the dog through the lock lever's engagement with the guide pin 216, between the engaged and non-engaging positions.

The lock lever or trigger arm 88 is a two-piece lever having a first arcuate component 218 and a second arcuate component 220. The first arcuate component has a dual seated head 222 to be described hereafter for receiving plug 224 mounted on the pull cord 32, a generally flat horizontally disposed arcuate main body 226 with an upstanding rib 228 following the contour of the horizontal body and at the opposite end a connector 230 for connection to the second component 220 of the lock lever. The connector 230 has four upstanding fingers 232 which straddle the upstanding rib 228 so as to define a seat for receiving a pair of depending fingers 234 (FIG. 8) at one end of the second component of the lock lever. The second component of the lock lever also has a generally flat, horizontally disposed arcuate body 235 with an upstanding rib 236. The upstanding rib 236 defines at its opposite end a rearwardly and downwardly inclined slot 238 in one face adapted to slidably receive the guide pin 216 on the dog. The first component of the lock lever is disposed beneath the bottom housing component 48 and is slidable relative to the bottom housing component with the connection between the first and second lock lever components extending through a slot (not seen) in the bottom housing component so the second segment of the lock lever is disposed within the housing and is slidably mounted for horizontal movement therein.

The interrelationship between the lock lever or trigger arm 88 and the dog 86 is probably best appreciated by reference to FIGS. 16A and 17A with FIG. 16A showing the lock lever and dog in the engaging position of the dog and FIG. 17A showing the lock lever and the dog in the non-engaging position of the dog. The coil spring 210 can be seen to releasably bias the dog into either the engaging or non-engaging positions so the dog does not easily leave either position.

As will also be appreciated, when the dog 86 is in the engaging position of FIG. 16A, the guide pin 216 is at the uppermost extent of the slot 238 in the second component 220 of the lever arm 88 and the lever arm is shifted to the left in an extreme position. When the lock lever is shifted to the right as shown in FIG. 17A, the inclined slot 238 in the lock lever forces the guide pin downwardly thereby pivoting the dog about its pivot pin 196 into the non-engaging position illustrated in FIG. 17A. The movement of the lock lever between the engaging and non-engaging positions of the dog will be described in detail hereafter but suffice it to say the movement is caused manually by manipulation of the pull cord 32.

As probably best appreciated by reference to FIG. 16A, 16B, 16C, 17A, 17B and 17C, the dual seated head 222 at the end of the first lock lever component 218 comprises an enlarged head at the end of the component having a dual cavity 242 of generally oblong cross-sectional configuration (FIG. 16D) opening downwardly. The oblong cavity defines two laterally connected positions or seats in which the plug 224 fixed on the pull cord 32 can be removably positioned. The position or seat 244 on the left as viewed in FIGS. 16C, 16D, FIGS. 17C and 17D has a circular hole 246 communicating upwardly through the head of the lock lever for slidable receipt of the pull cord but the hole is too small to permit passage of the plug 224. The size of the oblong cavity, however, is large enough to allow the plug to slide downwardly out of the cavity as when the pull cord is being pulled downwardly to raise the covering from an extended to a retracted position. When the pull cord is elevated or allowed to be wrapped around the spool 54, the plug will engage the top of the dual cavity and prevent further movement or wrapping of the pull cord about the spool. The other position or seat 248 within the cavity, to the right as viewed in FIGS. 16C, 16D, 17C and 17D, is of a size to receive the plug but has a pair of inwardly directed flanges 250 along a lower edge that define a space through which the pull cord can pass but will not permit downward movement of the plug when the plug is positioned in the right position or seat 248 of the oblong cavity. The flanges therefore prevent the pull cord from being pulled downwardly when the plug is positioned in the right position or seat of the cavity. It will also be appreciated, however, that by pulling the pull cord to the right as shown in FIGS. 17B and 17C the plug is shifted into the right position or seat of the dual cavity preventing the pull cord from being pulled downwardly any further. By pulling the cord to the right, the lock lever 88 is forced to slide to the right thereby causing the dog 86, as mentioned previously, to move from its engaged to its non-engaging position. It will also be appreciated when the plug is in the right position or seat of the dual cavity where it cannot move downwardly, the pull cord cannot be unwrapped from the spool 54 so that the spool shaft 56 and driven shaft 68 can likewise not be rotated.

To move the dog 86 from the non-engaging position of FIG. 17A to the engaging position of FIG. 16A, the pull cord 32 is simply pulled to the left moving the plug 224 into the left position or seat 244 of the dual cavity thereafter sliding the lock lever 88 to the left to move the dog to its engaging position of FIG. 16A. As mentioned previously, with the plug in the left position or seat of the dual cavity, it is free to move downwardly out of the cavity as when the pull cord is pulled downwardly so that in this position the pull cord can be pulled downwardly and allowed to retract the covering against the bias of the dual wrap coil spring 58 on the spool 54, and through repeated reciprocating movements of the pull cord, the covering can be raised any desired amount.

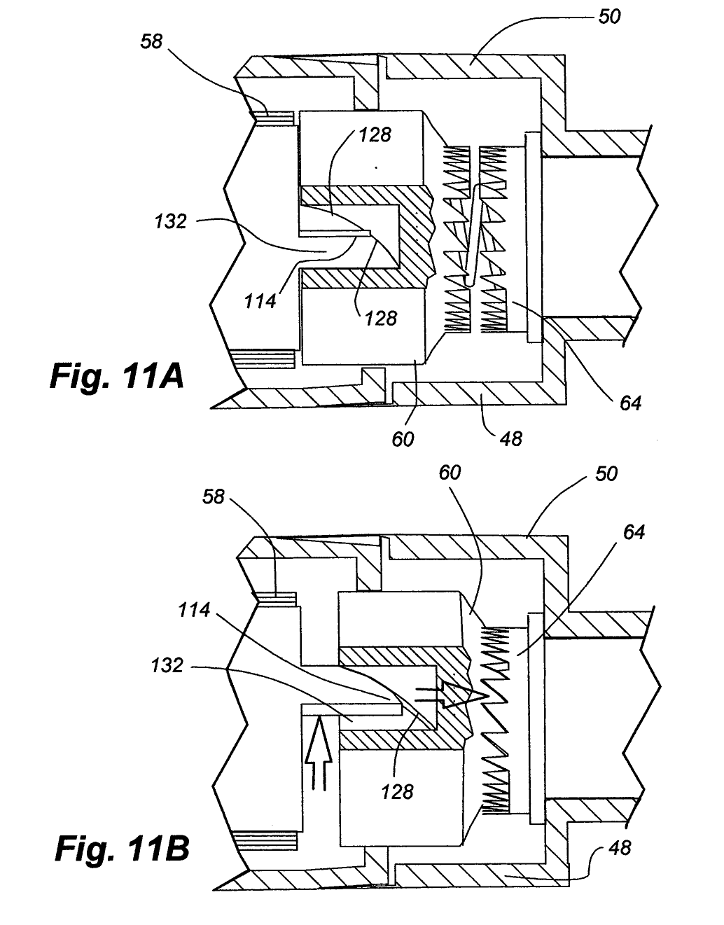

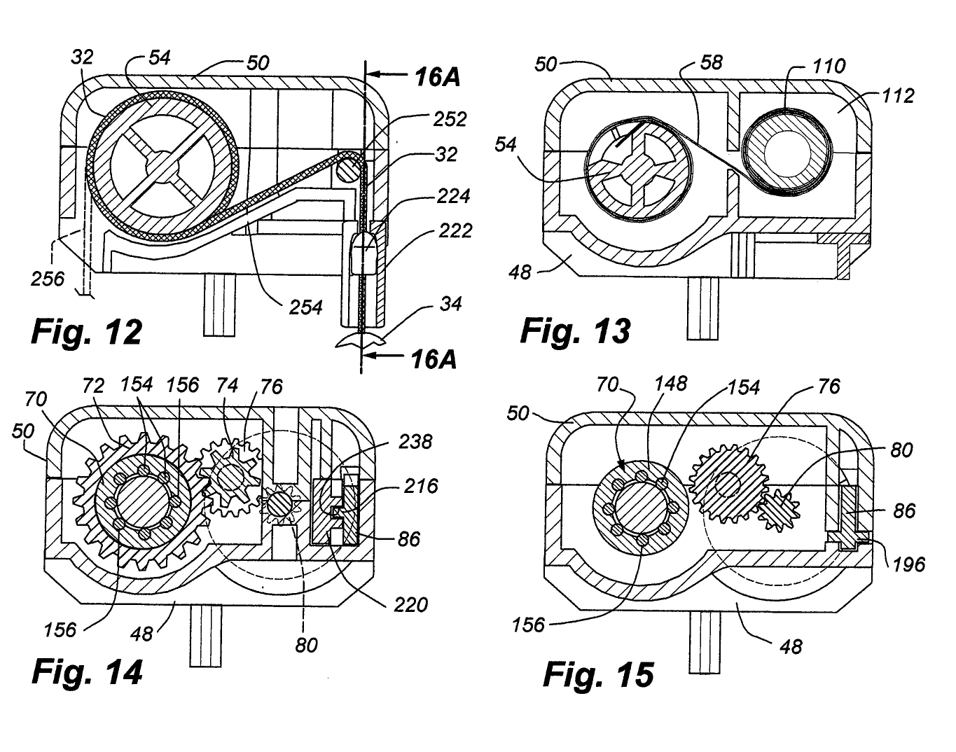

As probably best seen in FIG. 12, the pull cord 32 itself after passing upwardly through the dual cavity 242 in the lock lever 88, passes around a horizontal guide pin 252 and from there angularly downwardly along a ramp 254 defined in the bottom half 48 of the housing component from where it is fed to and around the spool 54. The pull cord is disposed at one end of the housing 46 so that the wrappings on the cord spool extend toward the opposite end. Also as shown in dashed lines 256 in FIG. 12, the cord can be wrapped from the opposite side of the spool if the control unit 22 were mounted at the opposite end of the head rail 28. In other words, the housing for the control unit is designed so it can be mounted at either end of the headrail, depending upon whether the covering has a left-hand draw (as shown) or a right-hand draw. The first component 218 of the lock lever (as viewed in FIG. 12) would be modified to position the dual cavity 242 thereon at the left side of the housing 46 so as to receive the pull cord 32 and plug 224 at the location where the pull cord is illustrated in the dashed lines 256. The modification of the lock lever is felt to be within the skill of those in the art and is therefore not described in detail herein.

In operation of the control unit 22, the pull cord 32 is normally disposed in the left position or seat 244 of the dual cavity 242 of the lock lever 58 so that the pull cord is free to be pulled downwardly pulling the plug 224 out of the cavity in reciprocating strokes of the pull cord. Each time the pull cord is pulled downwardly, the spool 54 is rotated in a clockwise direction as viewed in FIG. 9, or a counter-clockwise direction as viewed in FIG. 8. Of course, as the pull cord is pulled downwardly, it is unwound from the spool causing the spool to rotate against the bias of the dual wrap coil spring 58. As the cord is pulled downwardly, the coil spring 58 forms a second coiled wrap around the cylindrical spring wrap portion 104 of the spool thereby diminishing the size of the base coil 110 that is positioned in the pocket 112 within the housing 46. The dual wrap coil spring has been found to more linearly distribute the bias of the spring on the spool, which is tactilely more appealing to an operator.

When the spool 54 is rotating with the pull cord 32 being pulled downwardly, the tapered cam end 114 of the legs 62 on the spool shaft 68, which are engaged with the arcuate cams 128 in the drive gear 60 (FIGS. 11A and 11B), force the drive gear from its retracted position of FIG. 11A, into which it is biased by the coil spring 66 separating the drive gear from the driven gear 64, into the extended position of FIG. 11A where the drive gear is forced away from the spool and into operative engagement with the driven gear. The teeth on the drive gear and the driven gear are therefore engaged so that the driven gear is forced to rotate in the same direction and in unison with the drive gear.

Rotation of the driven gear 64 also causes the driven shaft 68 to rotate in this same first direction so that the lift shaft 36 of the covering 20 is also rotated in this direction which is a direction that causes the lift cords 40 to wrap around their associated lift spools 38 raising the bottom rail 30 of the covering toward the head rail 28 thereby retracting the covering. Each downward stroke of the pull cord 32 raises the bottom rail a pre-determined increment so that the bottom rail is fully raised through a plurality of such incremental movements.

When the pull cord 32 is allowed to rewind under the bias of the dual wrap coil spring 58, the spool 54 rotates in the opposite direction thereby re-wrapping the pull cord about the spool and in doing so the tapered or beveled ends 114 of the legs 62 on the spool shaft move in an opposite direction along the arcuate cam webs or ridges 128 in the drive gear 60 so that the drive gear is shifted to the left and disengaged from the driven gear 64 as viewed in FIGS. 11A and 11B from the position of FIG. 11B to the position of FIG. 11A under the bias of the coil spring 66 interconnecting the drive gear and the driven gear. Accordingly, as the pull cord is being re-wrapped about the spool there is no operative engagement between the drive gear and the driven gear. The driven gear remains motionless even though gravity is acting on the bottom rail 30 of the covering 20 wanting to rotate the lift spools, the lift shaft, the driven shaft and the driven gear that are all operatively interconnected. The opposite rotating movement of these components is prevented by the gear train, which is fixed to the one-way bearing 70 that will not rotate in that direction about the driven shaft 68. Accordingly, as long as the gear train is prevented from rotation by the dog 88 being in its engaged position with the rotatable plate 82 on the governor 44, the driven shaft cannot rotate in the opposite direction.

Through the reciprocating movements of the pull cord 32, it will be appreciated the bottom rail 30 of the covering 20 can be raised in increments and will remain in a fixed elevated position until the pull cord is again pulled downwardly in as much as the brake assembly 42 prevents an opposite rotation of the lift shaft 36 which would permit the bottom rail to drop by gravity.

If at any point in the retraction of the covering 20, it is desired that it be allowed to extend by dropping the bottom rail 30, however, it is simply necessary to pull the pull cord 32 laterally to the right as viewed in FIGS. 16A, 16B, 16C, 17A, 17B and 17C until the plug 224 on the pull cord shifts into the right position or seat 248 of the oblong cavity 242 of the lock lever such that further movement of the plug to the right causes the lock lever to shift to the right which, in turn, causes the dog 86 to be disengaged from the rotatable plate 82 of the governor. Since gravity is always acting on the bottom rail 30 of the covering, the force of gravity rotates the lift shaft 36, the driven shaft 68, as well as the pinion gear train, and the governor 44 in the opposite direction, which is then permitted since the dog is no longer preventing the rotating plate of the governor from rotating. Accordingly, the bottom rail is then permitted to drop since the brake assembly 42 has released the system and as the bottom rail is dropping, the lift cords 40 are unwound from their associated lift spools 38 in the head rail 28. While the lift shaft rotates in the opposite direction, the driven shaft 68 is also rotated in that same direction. Of course rotation of the driven shaft in that direction causes the one-way bearing 70 and the gear train associated therewith to also rotate in that opposite direction which in turn rotates the governor causing the floating friction bars 96 to pivot outwardly into frictional engagement with the inner cylindrical wall of the governor base 90. The rotating movement is therefore permitted but restricted in speed by the governor so that the covering does not drop too rapidly from a retracted position to an extended position.

The extension of the covering 20, by allowing the bottom rail 30 to drop by gravity upon releasing the brake, can be terminated at any point by merely shifting the pull cord 32 into the left position or seat of the oblong cavity, and thereafter pulling the lock lever to the left and moving the dog 86 into its engaged position with the rotatable plate 82, which prevents further rotation of the driven shaft 68 and the lift shaft 36.

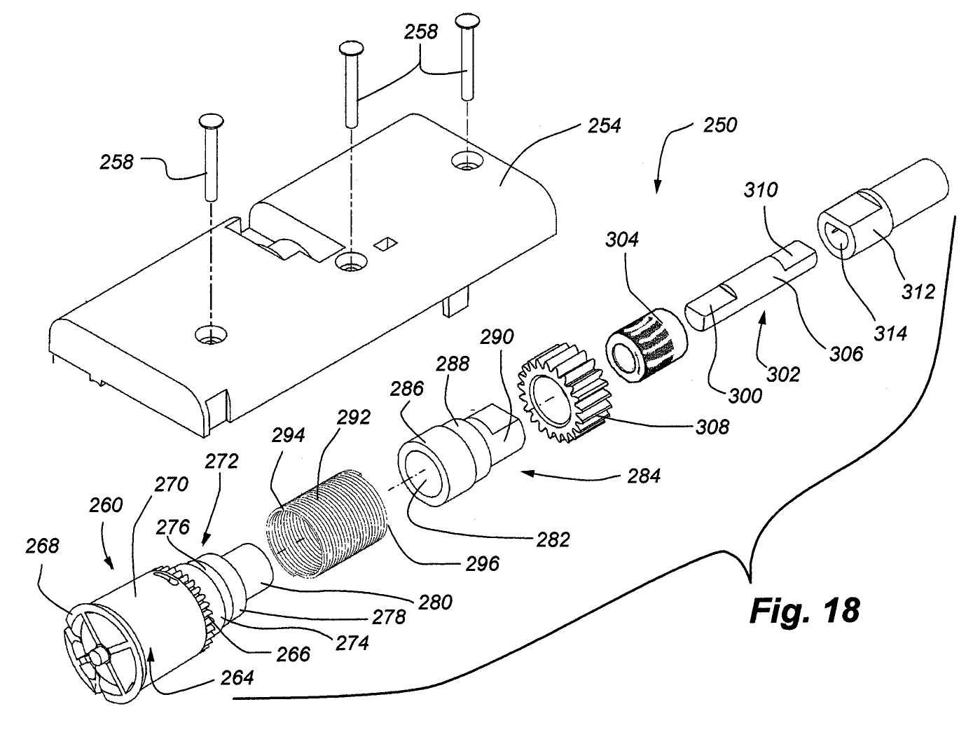

A second embodiment of the control unit of the present invention is illustrated in FIGS. 18-31 with the second embodiment of the control unit being very similar to the first-described embodiment except the drive assembly 250 of the second-described embodiment is different from that of the first-described embodiment while the brake assembly 252 is substantially identical and, therefore, will not again be described in detail. The housing for the second embodiment is also a two-part housing having a top component 254 and a bottom component 256 releasably interconnected with fasteners 258. The top and bottom components are molded to include compartments for housing the various components of the drive assembly and brake assembly. The housing components will not be described in detail except that specific features thereof as they play a role in the operation of the drive assembly will be identified.

The drive assembly 250 of the second embodiment is probably best appreciated by reference to FIGS. 18-20. It will there be seen the drive assembly includes a cord spool 260 about which the pull cord 262 can be wrapped and unwrapped with the cord spool having a cylindrical drum 264 at one end with an integral circumferential gear 266 thereon. The opposite end of the cord spool from the circumferential gear is beveled at 268 so as to retain the pull cord on a cylindrical wrap surface 270 of the cord spool when it is wrapped therearound. The bevel facilitates unwrapping and wrapping of the pull cord about the cord spool in a controlled manner. The cord spool is biased in a wrapping direction by a biasing spring 271 to be described later.

Extending axially away from the gear 266 of the cord spool 260 is a support shaft 272 having first 274, second 276, third 278 and fourth 280 axially contiguous segments of respectively diminishing diameter that are coaxial with the cylindrical drum 264 of the wrap spool. The smallest diameter segment or fourth segment is adapted to be rotatably received in a cylindrical, axial blind hole 282 in a first end of a spool shaft 284. The spool shaft has a large diameter cylindrical shaft portion 286 at the first end, an integral reduced intermediate cylindrical shaft portion 288 next thereto, and an integral small diameter substantially cylindrical shaft portion 290 at an opposite second end.

The outer diameter of the second 276 and third 278 support shaft segments of the cord spool 260 are substantially commensurate in outside diameter with the large diameter portion 286 of the spool shaft 284. The large diameter portion of the spool shaft has the blind hole 282 recessed axially therein with the diameter of the blind hole slightly larger than the diameter of the smallest or fourth support shaft segment 280 of the cord spool. Accordingly, the fourth support shaft segment is rotatably seated in the blind hole.

A coil spring 292, that functions as a spring clutch, has a first end 294 seated on the second 276 and third 278 support shaft segments of the cord spool 260, and a second end 296 seated on the large diameter portion 286 of the spool shaft so the spring clutch bridges the interface between the support shaft 272 of the cord spool and the cord spool shaft 284. As will be described later, the spring clutch permits rotation of the cord spool relative to the spool shaft in a wrapping direction while causing unitary rotation of the cord spool with the spool shaft in an opposite unwrapping direction.

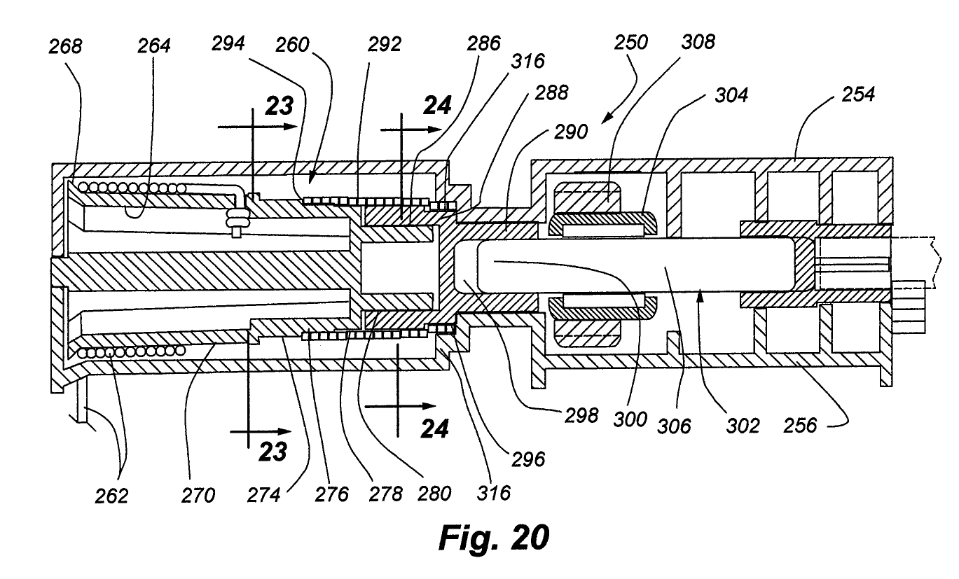

The opposite end of the spool shaft 284 has a second blind hole 298 (FIG. 20) that is non-circular in transverse cross-section. It is in the disclosed embodiment partially cylindrical with a flat chord wall. The second blind hole 298 is adapted to receive a first end 300 of a driven shaft 302, which is identical to the driven shaft 68 of the first-described embodiment. As previously described, the first end 300 of the driven shaft, as seen in FIG. 18, is configured in cross-section identically to that of the second blind hole in the spool shaft so as to rotate in unison therewith. The driven shaft further has a conventional one-way bearing 304, identical to the one-way bearing 70 of the first-described embodiment, with the bearing mounted on a central portion 306 of the driven shaft so that the bearing will rotate in one direction relative to the driven shaft but not in the opposite direction. The bearing has frictionally fit on its outer surface a pinion gear 308, identical to the pinion gear 72 of the first-described embodiment, so the pinion gear rotates in unison with the one-way bearing. The opposite or second end 310 of the driven shaft receives, as in the first embodiment, a lift shaft 312, which is identical to the lift shaft 36 of the first-described embodiment, with the lift shaft having at its first end a blind hole 314 of non-circular cross-section mating with the configuration of the second end 310 of the driven shaft.

As probably best seen in FIG. 20, when the components of the drive assembly are positioned within the housing components 254 and 256, the housing components at 316 lightly compress the second end 296 of the coil spring 292 clutch so the coil spring clutch is loosely seated on the intermediate shaft portion 288 of the spool shaft 284. The tolerances between the housing at 316, the coil spring 292, and the intermediate shaft portion 288 of the spool shaft are such that rotation of the coil spring, which is caused by rotation of the cord spool 260 in the unwrapping direction, as will be described hereafter, causes the coil spring to grip the spool shaft 284 due to the friction between the coil spring and the surrounding housing components which thereby causes the spool shaft to rotate with the clutch spring. Rotation of the clutch spring in an opposite wrapping direction, however, permits slippage between the spool shaft and the clutch spring so the spool shaft does not rotate with the clutch spring in the wrapping direction.

The opposite or first end 294 of the clutch spring 292, which is seated on the second 276 and third 278 segments of the support shaft 272, as seen in FIG. 20, is frictionally engaged with the support shaft even though rotation of the cord spool 260 and its support shaft in the wrapping direction allows the support shaft to slip relative to the coil spring in a conventional clutch spring manner while rotation of the support shaft in the unwrapping direction causes the clutch spring to grip the support shaft thereby rotating in unison therewith. The direction in which the clutch spring is caused to rotate with the cord spool is the unwrapping direction, which occurs when the pull cord is pulled and unwrapped from the cord spool. This same direction of rotation causes the clutch spring to grip the spool shaft causing the spool shaft to rotate therewith. When the cord spool is rotated in the opposite direction, i.e. a wrapping direction, as when the pull cord 262 is allowed to rewrap about the cord spool, the support shaft of the cord spool slips relative to the clutch spring and the clutch spring does not, therefore, transfer rotation to the spool shaft so it remains stationary.

As will be appreciated from the above description of the components of the drive assembly, when the spool shaft 284 is rotating in an unwrapping direction of the cord spool, it causes the pinion gear 308 to rotate with the driven shaft 302, which also causes the lift shaft 312 to rotate in unison therewith. However, when the cord spool is rotated in a wrapping direction, the spool shaft, driven shaft, and lift shaft are not encouraged to rotate and will remain in place through operation of the brake assembly 252, as described previously in connection with the first embodiment of the control unit. Of course, the brake assembly can be selectively released through manipulation of the pull cord 262, as described with the first embodiment, to permit rotation of the spool shaft, driven shaft, and lift shaft as is caused by the weight of the shade material operatively associated with the lift shaft for the covering.

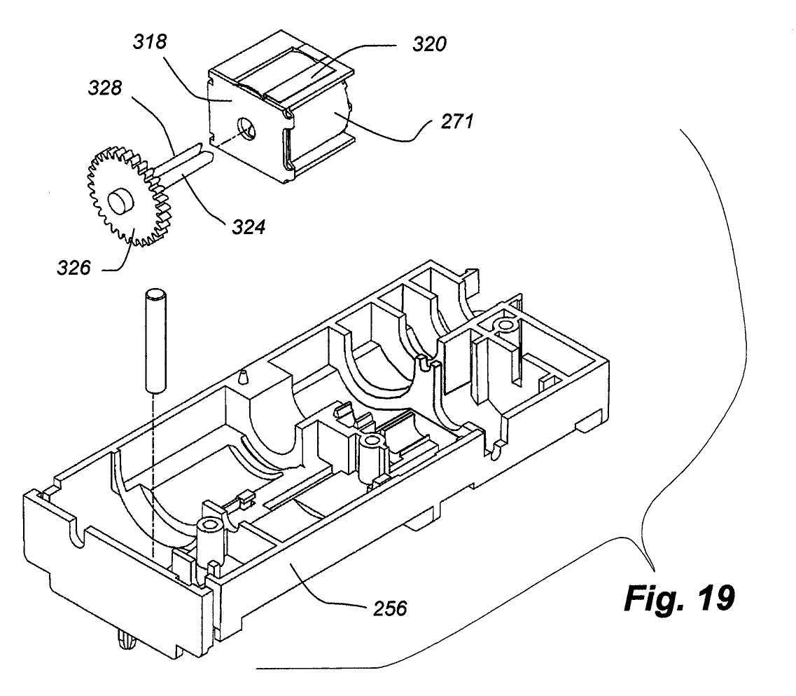

With reference to FIG. 19, it will be appreciated the biasing coil spring 271 is mounted in a housing 318 so that the outer end 320 of the spring is operatively engaged with the housing while the inner end 322 of the spring is connected with a shaft 324 associated with a drive gear 326 meshed with the integral gear 266 of the cord spool 260. Accordingly, rotation of the drive gear causes the biasing coil spring 271 to either be coiled or uncoiled. Of course, it is coiled against its bias when the cord spool is rotated in an unwrapping direction as when the pull cord is being pulled, but when the pull cord is no longer being pulled, the biasing spring uncoils or unwinds causing the drive gear to rotate in an opposite direction thereby causing the cord spool to rotate in a wrapping direction to rewind the pull cord thereabout.

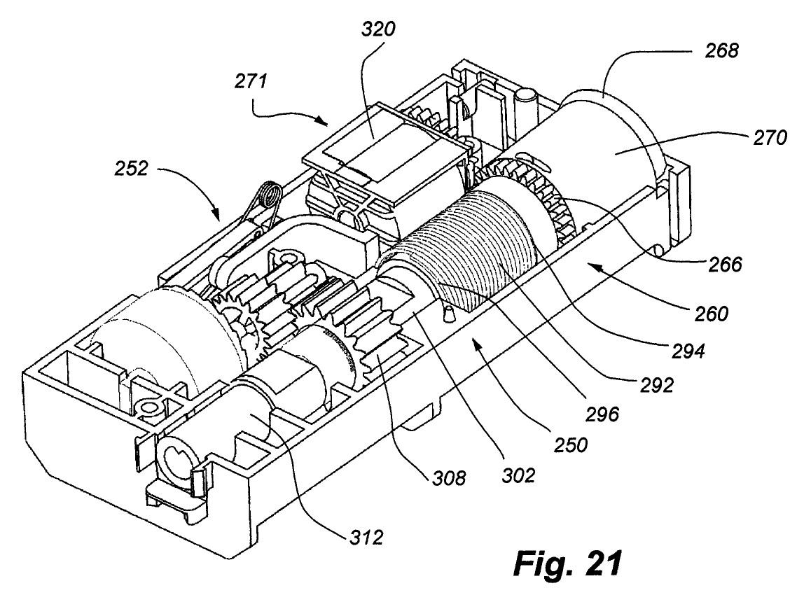

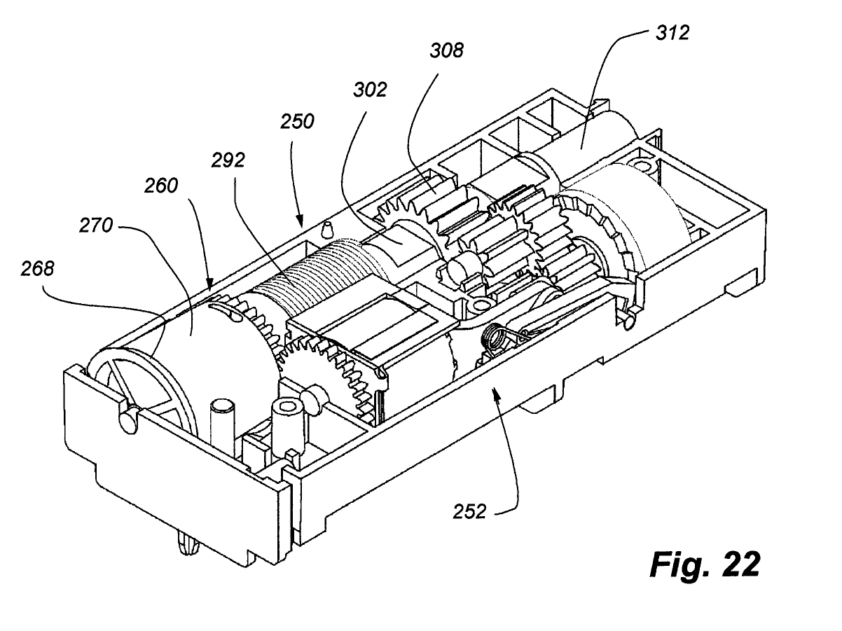

FIG. 21 shows the components of the drive assembly 250 of the second embodiment of the control system incorporated in one half of the housing and in operative engagement and relationship with the brake assembly 252. FIG. 22 is an isometric view similar to FIG. 21 showing the components from a different direction.

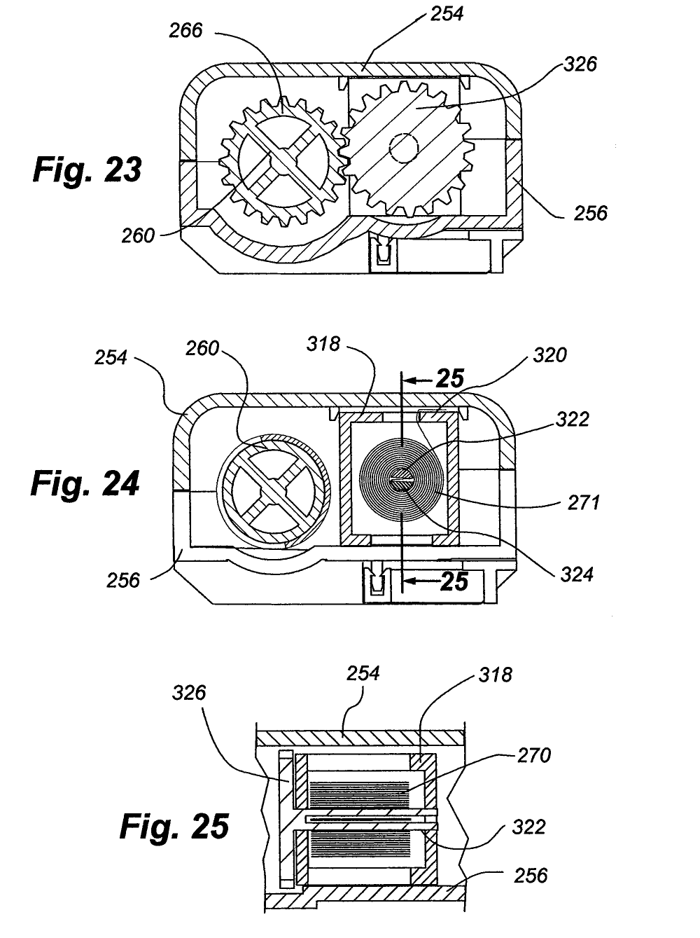

FIG. 23 is a section through the control unit showing the drive gear 326 on the biasing coil spring 271 engaged with the integral circumferential gear 266 on the cord spool 260 so that the two gears rotate in unison even though in opposite directions.

FIG. 24 shows the coil spring 271 used to bias the cord spool in a fully coiled position and poised to rewrap the pull cord 262 about the cord spool when it is no longer being pulled downwardly.

FIG. 25 shows the biasing coil spring 271 with its drive gear 326 operatively associated therewith where it can be seen the innermost end 322 of the coil spring is operatively engaged in a slot 328 provided in the shaft 324 of the drive gear 326 so that rotation of the drive gear in one direction causes the coil spring to be coiled while uncoiling of the spring causes an opposite rotation of the drive gear, which of course is transferred to the cord spool 260 as mentioned previously.

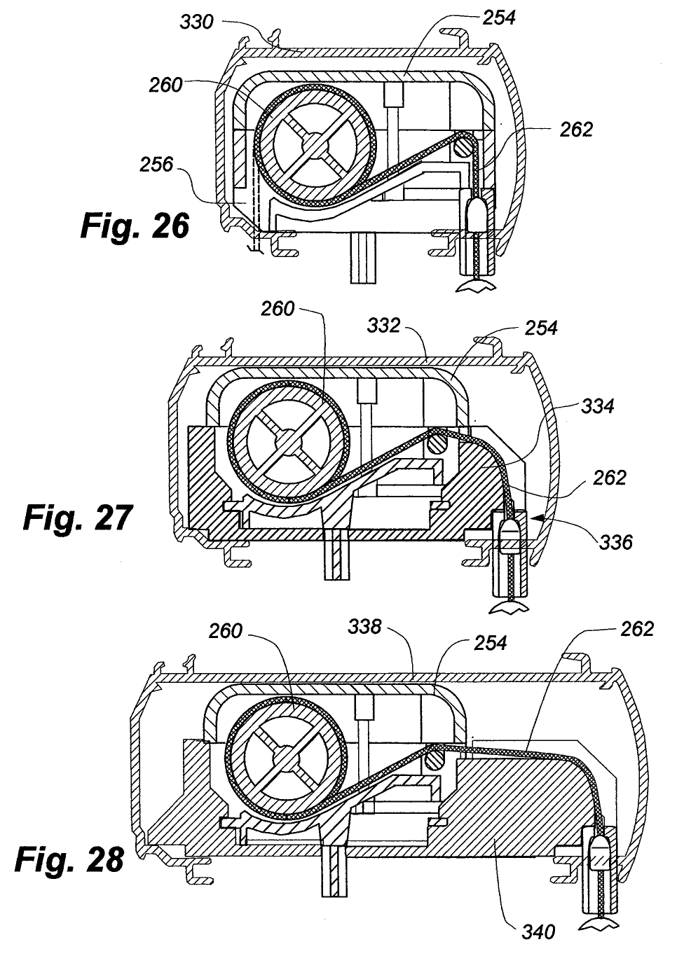

FIG. 26 is a vertical section through the control unit of the second embodiment of the invention mounted within a headrail 330 showing the pull cord 262 wrapped about the cord spool and being positioned for operation identically to that described in connection with the first embodiment of the control unit.

FIG. 27 is a section similar to FIG. 26 wherein the control unit is mounted in a slightly larger headrail 332 and a cord guide block 334 is positioned within the headrail to properly align the pull cord with an exit 336 from the control unit at an appropriate location within the headrail.

FIG. 28 shows the control unit in an even larger headrail 338 with an even larger guide block 340 provided for the pull cord 262 to again properly position the pull cord for operation at an appropriate location within the headrail.

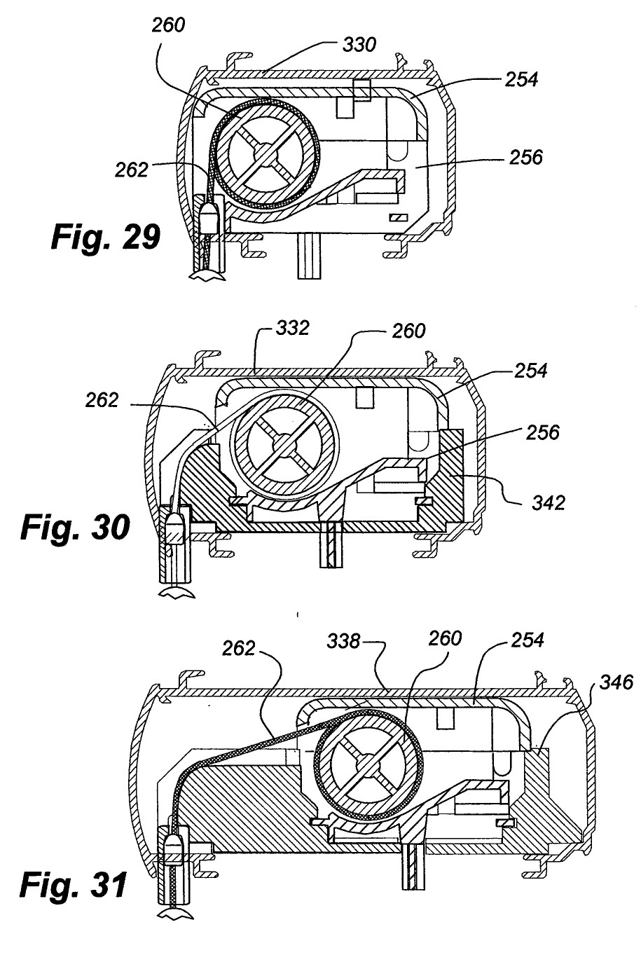

FIG. 29 is a section similar to FIG. 26 but wherein the pull cord 262 is disposed on an opposite side of the headrail.

FIG. 30 is a section similar to FIG. 27 with the pull cord 262 disposed on an opposite side from that of FIG. 27 and wherein a cord guide block 342 is positioned within the headrail for properly positioning the pull cord for operation.

FIG. 31 is a section similar to FIG. 28 wherein the pull cord 262 is disposed on an opposite side from that of FIG. 28 and positioned within an even larger headrail 344. Another cord guide block 346 is positioned for guiding the pull cord and properly positioning the cord for operation in accordance with the invention.

Although the present invention has been described with a certain degree of particularity, it understood the disclosure has been made by way of example, and changes in detail or structure may be made without departing from the spirit of the invention as defined in the appended claims.

1. A control unit for controlling a lift system in a covering for an architectural opening operated by a lift shaft wherein said covering is raised by said lift system and allowed to drop by gravity, comprising in combination:
a drive assembly including a spool with a pivot shaft and an axis of rotation,
a substantially longitudinally inextensible pull cord having one end anchored to the spool and a second end for manipulation by an operator of the control unit, a resilient member operatively biasing said spool in a first direction for rotative movement about its axis of rotation to wrap said pull cord around the spool, a system for limiting rotative movement of said spool in said first direction, a drive gear mounted on said spool shaft for unitary rotation with said spool, and a system for axially moving said drive gear away from said spool when said spool is rotated in a second direction opposite to said first direction, and
a brake assembly including a driven shaft and a driven gear operatively connected to said driven shaft for unitary rotation therewith, said driven gear being operatively engageable with said drive gear when said drive gear is axially moved away from said spool, a resilient system for biasing said drive gear toward said spool to disengage said drive gear from said driven gear, and wherein said driven shaft is adapted to be operatively connected to said lift shaft.

2. The unit of claim 1 wherein said resilient member is a coil spring.

3. The unit of claim 1 wherein said system for axially moving said drive gear is a cam system.

4. The unit of claim 3 wherein said cam system includes a cam surface on at least one of said drive gear and spool shaft.

5. The unit of claim 4 wherein said cam system includes a cam surface on both of said drive gear and spool shaft.

6. The unit of claim 4 wherein said cam surface is along an arc of a circle concentric with said spool shaft.

7. The unit of claim 1 wherein said resilient system comprises a coil spring operatively engaged with said drive gear and said driven gear to bias them apart.

8. The unit of claim 2 wherein said coil spring is a double-wrapped coil spring.

9. A control unit for controlling a lift system in a covering for an architectural opening operated by a lift shaft wherein said covering is raised by said lift system and allowed to drop by gravity, comprising in combination,
a drive assembly including a unidirectionally driven drive gear and a pull cord for unidirectionally rotating said drive gear, and
a brake assembly including a driven shaft and a driven gear operatively connected to said driven shaft for unitary rotation therewith, said driven gear being selectively engageable with said drive gear, said driven shaft being operatively connected to said lift shaft, a governor operatively connected to said driven shaft, a one-way brake on said driven shaft to permit rotation of said driven shaft in one direction while selectively prohibiting rotation in an opposite direction, a dog operatively associated with said one-way brake for selectively permitting or prohibiting rotation of said driven shaft in said opposite direction.

10. The unit of claim 9 wherein said one-way brake includes a one-way bearing.

11. The unit of claim 10 wherein said one-way bearing interconnects a second driven gear with said driven shaft.

12. The unit of claim 11 further including a governor gear rotatable with said governor, a gear train operatively connecting said second driven gear with said governor gear and wherein said dog is movable being engaging and non-engaging positions relative to said governor gear, said dog in said engaging position preventing rotation of said governor and rotation of said driven shaft in said opposite direction and in said non-engaging position permitting rotation of said governor and said driven shaft in said opposite direction.

13. The unit of claim 12 further including a lock lever for moving said dog between engaging and non-engaging positions, said lock lever being operatively associated with said pull cord whereby said dog is movable between said engaging and non-engaging positions through manipulation of said pull cord.

14. The unit of claim 9 further including a resilient system for biasing said drive gear away from said driven gear.

15. The unit of claim 14 wherein said resilient system is a coil spring.

16. The unit of claim 9 wherein said governor is operative to control the rate of rotation of said driven shaft in said opposite direction.

17. A control unit for controlling a lift system in a covering for an architectural opening operated by a lift shaft wherein said covering is raised by said lift system and allowed to drop by gravity, comprising in combination:
a driven assembly including a rotatable spool, a pull cord secured to said spool for wrapping on and unwrapping therefrom, a biasing spring operatively connected to said spool to bias said spool in a wrapping direction, a spool shaft operatively connected to said spool with a clutch spring for unidirectionally rotating said spool shaft in an unwrapping direction of rotation of said spool, a driven shaft operatively connected to said spool shaft for unitary rotation therewith, and a lift shaft operatively connected to said driven shaft for unitary rotation therewith.

18. The control unit of claim 17 wherein said spool includes an integral support shaft on which said clutch spring is operatively mounted.

19. The control unit of claim 18 further including a releasable braking assembly for selectively preventing said lift shaft from rotating when said spool is rotated in said wrapping direction.

20. The control unit of claim 18 further including a releasable braking assembly for selectively preventing said lift shaft from rotating when said spool is not rotating.
